(19) United States
(12) Patent Application Publication
(10) Pub. No.: US 2012/0160989 A1
(43) Pub. Date: Jun. 28, 2012

(54) EYEWEAR MOUNTING DEVICE

(75) Inventors: Kazuto YASUHARA, Osaka (JP); Naoya AOYAMA, Osaka (JP)

(73) Assignee: YAMAMOTO KOGAKU CO., LTD., Osaka (JP)

(21) Appl. No.: 13/302,459

(22) Filed: Nov. 22, 2011

(30) Foreign Application Priority Data
Dec. 28, 2010 (JP) 2010-293922

(51) Int. Cl. G02C 3/02

(52) U.S. Cl. 248/693

(57) ABSTRACT

In an eyewear mounting device, a pressing surface portion is formed at an end of a frame, a pair of supporting arms is provided on the pressing surface portion at an interval, a shaft around which a tightening band is wound is provided between tips of the supporting arms. An operating member rotationally attached between the supporting arms has a pressing operation portion, a pulling-up operation portion, an elastic piece and an engaging claw. The engaging claw is engageable with any of a plurality of protruding portions provided in a longitudinal direction of a surface side of the tightening band. This configuration results in easy operation of the operating member in the state where the eyewear mounting device is worn on the face. Further, only one operating member is used as the component member, thus resulting in easy assembly of the eyewear mounting device.

### CROSS REFERENCE TO RELATED APPLICATIONS

This application claims priority of Japanese application no. 2010-293922 filed on Dec. 28, 2010, the entire contents of which is hereby incorporated by reference herein.

### BACKGROUND OF THE INVENTION

1. Field of the Invention

The present invention relates to eyewear mounting devices, such as those used for various types of goggles, glasses, and masks to which tightening bands are attached.

2. Description of the Related Art

Conventionally, for example, as disclosed in Japanese Utility Model Publication No. 59-25414, a swimming goggle as shown in FIGS. 5 and 6 is included in these kinds of eyewear mounting devices. In the swimming goggle, plates 23a and 23b are arranged substantially in centers of respective side portions 22a and 22b of a glasses body 21 with a space of approximately equal to a band width between the plates 23a and 23b. Additionally, a band through hole 24a is formed in a back plate 24 continuous with the plates 23a and 23b, and a tightening band 25 on which projections 25a in a width direction are intermittently formed is passed through the band through hole 24a. Further, a wearing piece 27 is turnably pivotally supported by a shaft 26 passed between the plates 23a and 23b, and the wearing piece 27 is rotationally biased by springs 28 in a direction where a hook portion 27a, which is one side portion of the wearing piece 27, always bites into between the projections 25a of the tightening band 25.

In a conventional eyewear mounting device configured as described above, first, a pushing portion 29 of the wearing piece 27 is pushed to separate the hook portion 27a from the tightening band 25 in order to adjust a tightened condition by the tightening band 25. In so doing, the tightening band 25 can freely move in the above-described state, thus allowing the tightening band 25 to be adjusted for being pulled out and shortened.

Further, in the conventional eyewear mounting device, if the push to the wearing piece 27 is released after the tightening band 25 is adjusted as described above, the wearing piece 27 is rotationally biased in a direction where the band is pushed by a force of the springs 28, and thus the hook portion 27a bites into between the projections 25a of the tightening band 25 to thereby fix a position of the tightening band 25.

Accordingly, in the above-described conventional eyewear mounting device shown in FIGS. 5 and 6, if the wearing piece 27 is simply pushed to separate the hook portion 27a from the tightening band 25, a length of the tightening band 25 can be adjusted freely, and, conversely, if the push to the wearing piece 27 is released, the hook portion 27a bites into the tightening band 25 to secure the tightening band 25 and therefore, the tightening band 25 is firmly worn with a fixed length, thus enabling to adjust the tightened condition by the tightening band 25 with fingertips.

In addition, for example, as disclosed in Japanese Utility Model Laid-Open No. 5-91636, a swimming mask as shown in FIGS. 7 to 9 is included in these kinds of eyewear mounting devices. The swimming mask comprises a fastening force adjuster of a tightening band. The fastening force adjuster has a pair of supporting pieces 31 and is comprised of: a buckle 33 provided with a guiding shaft 32 between tips of the supporting pieces 31; a tightening band 34 that is hanged over the guiding shaft 32 to be folded; and an operating member 35 slidably provided to the guiding shaft 32 between the supporting pieces 31. Additionally, at a back surface side of a surface slidingly in contact with the guiding shaft 32 of the tightening band 34, a plurality of protruding portions 34a are provided with a required interval in a longitudinal direction of the tightening band 34. Further, on a surface of the each protruding portion 34a, provided is a tapered surface 34c that inclines toward a direction where a folded band 34b of the tightening band 34 is pulled, and an engaging claw 35a that can engage with one of the protruding portions 34a is formed at the operating member 35. In addition, integrally with the buckle 33, provided is an elastic piece 36 that prevents the operating member 35 from sliding in a direction departing from the guiding shaft 32 to hold the engaging claw 35a in a state of engaging with the protruding portion 34a, and that elastically deforms when the operating member 35 is pressed to slide to the back.

In the conventional eyewear mounting device configured as described above, the tapered surface 34c of the protruding portion 34a presses the engaging claw 35a by pulling the folded band 34b of the tightening band 34, and thus the operating member 35 can slide to the back to thereby strengthen a fastening force of the tightening band 34.

Further, in the conventional eyewear mounting device, the engaging claw 35a departs from the guiding shaft 32 to release engagement with the protruding portion 34a by sliding the operating member 35 to the back with the press of fingertips, thus enabling to reduce the fastening force by pulling the tightening band 34.

Accordingly, since the fastening force of the tightening band 34 can be strengthened by pulling the folded band 34b, and the tightening band 34 can be loosened by sliding the operating member 35 in the above-described conventional eyewear mounting device shown in FIGS. 7 to 9, it is not necessary to remove the swimming mask when the fastening force of the tightening band 34 is adjusted and therefore, it can be adjusted in a state of wearing the swimming mask.

However, in the above-described conventional eyewear mounting device shown in FIGS. 5 and 6, it is necessary to push the pushing portion 29 of the wearing piece 27 and to thereby shorten the springs 28 in order to loosen the tightening band 25 and is necessary to push with a strong force since a vicinity of an upper side of the springs 28 is pushed, and thus there has been a problem that the tightening band 25 is hard to be operated in a state where the eyewear mounting device is worn.

Further, although it is defined that a user only has to perform operation of only pushing the vicinity of the upper side of the springs 28 in order to loosen the tightening band 25 in the above-described conventional eyewear mounting device, the operation is hard to be performed only by pushing the vicinity of the upper side of the springs 28 in the state where the eyewear mounting device is worn on a face, and thus there has been a problem of being inconvenient.

In addition, the above-described conventional eyewear mounting device is comprised of two components of the wearing piece 27 and the springs 28 as component members for loosening the tightening band 25, and thus there has been a problem that the number of components is plural and the eyewear mounting device is hard to be assembled.

Additionally, although the above-described conventional eyewear mounting device shown in FIGS. 7 to 9 is configured to loosen the tightening band 34 by sliding the operating member 35, there has been a problem that fingers easily slip in sliding operation and that the operation is hard to be performed in the state where the eyewear mounting device is worn on the face.

Further, although it is defined that the user only has to perform operation of only sliding the operating member 35 in order to loosen the tightening band 34 in the above-described conventional eyewear mounting device, the operation is hard to be performed only by sliding the operating member 35 in the state where the eyewear mounting device is worn on the face, and thus there has been a problem of being inconvenient.

In addition, since the above-described conventional eyewear mounting device is also comprised of two components of the buckle 33 and the operating member 35 as component members for loosening the tightening band 34, there has been a problem that the number of components is plural and thereby the eyewear mounting device is hard to be assembled similarly to the eyewear mounting device shown in FIGS. 5 and 6.

Consequently, an object of the present invention is to solve the above-described conventional problems, and the present invention aims at providing a eyewear mounting device in which in a state of being worn on a face, an operating member is easily operated, a tightening band can be loosened by either operation of pushing the operating member or pulling it up, and in which a component member for loosening the tightening band is made to be one operating member.

### SUMMARY OF THE INVENTION

Therefore, in an eyewear mounting device of the present invention, a pressing surface portion is formed at an end of a frame, a pair of supporting arms are provided on the pressing surface portion at an interval, a shaft around which a tightening band is wound is provided between tips of the supporting arms, and an operating member is rotationally attached between the supporting arms. An inner end of the operating member serves as a pressing operation portion and an outer end thereof serves as a pulling-up operation portion, an elastic piece that is elastically deformed by pressing the pressing surface portion of the frame is provided at the pressing operation portion, an engaging body having an engaging claw is provided at an intermediate portion of the pressing operation portion and the pulling-up operation portion, and the engaging claw of the engaging body is engageable with any of a plurality of protruding portions provided in a longitudinal direction of a surface side of the tightening band that is wound around the shaft and is folded.

Additionally, the operating member is made of an integrally molded product of synthetic resin in the eyewear mounting device of the present invention.

Further, in the eyewear mounting device of the present invention, a pair of supporting pieces is provided at the operating member in a state of being opposed to the pressing operation portion, supporting projections formed at tips of the supporting pieces are supported by supporting holes formed in the supporting arms, respectively, and thereby the operating member is rotatably attached between the supporting arms.

In addition, in the eyewear mounting device of the present invention, a space serving as a rotating region of the operating member is provided between the elastic piece of the operating member and the pressing surface portion of the frame.

Further, in the eyewear mounting device of the present invention, an engaging portion is provided between the supporting arms between the shaft and the pressing surface portion, and the engaging body has an engaging piece, and the engaging piece engages with the engaging portion to prevent the operating member from rotating more when the operating member is rotated.

Since the eyewear mounting device of the present invention is configured as described above, the operating member is easily operated, the tightening band can be loosened by either operation of pushing the operating member or pulling it up in the state where the eyewear mounting device is worn on the face, thus resulting in the very convenient eyewear mounting device.

Further, in the eyewear mounting device of the present invention, only one operating member is used as the component member for loosening the tightening band, thus resulting in easy assembly of the eyewear mounting device.

### BRIEF DESCRIPTION OF THE DRAWINGS

FIG. 1 is a perspective view showing one embodiment of an eyewear mounting device of the present invention;

FIG. 2 is an exploded perspective view of a main portion of the eyewear mounting device of the present invention shown in FIG. 1;

FIG. 3 is a cross-sectional view in a state where a tightening band of the eyewear mounting device of the present invention shown in FIG. 1 is tightened;

FIG. 4 is a cross-sectional view in a state where the tightening band of the eyewear mounting device of the present invention shown in FIG. 1 can be loosened;

FIG. 5 is a perspective view showing one example of a conventional eyewear mounting device;

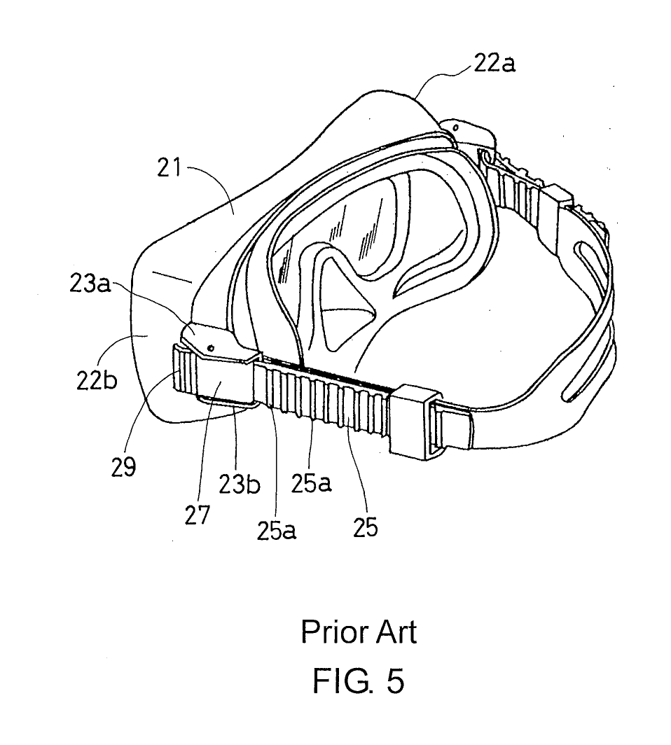

FIG. 6 is a cross-sectional view in a state where a tightening band of the conventional eyewear mounting device shown in FIG. 5 is tightened;

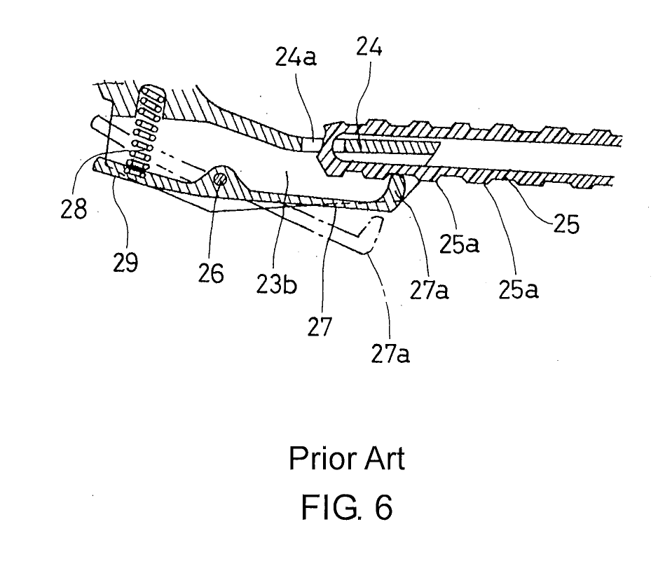

FIG. 7 is a perspective view showing another example of the conventional eyewear mounting device;

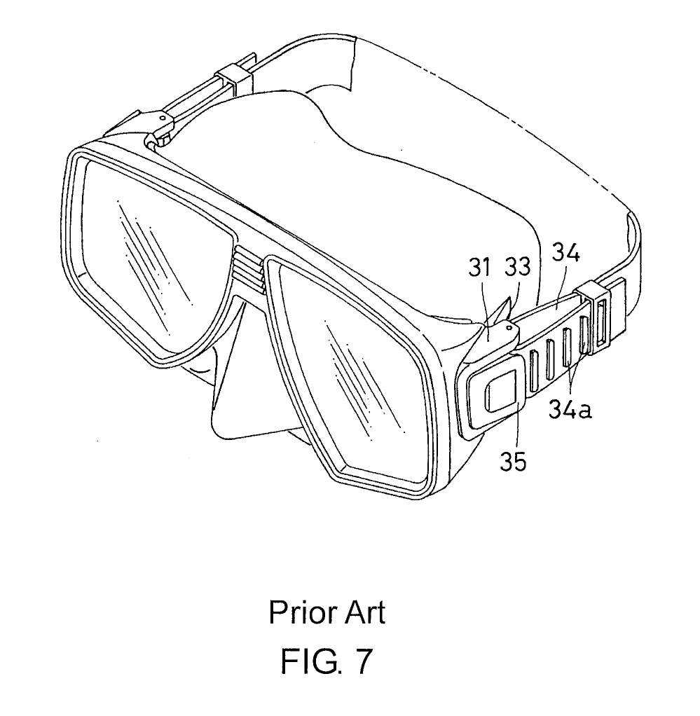

FIG. 8 is a cross-sectional view in a state where a tightening band of the conventional eyewear mounting device shown in FIG. 7 is tightened; and

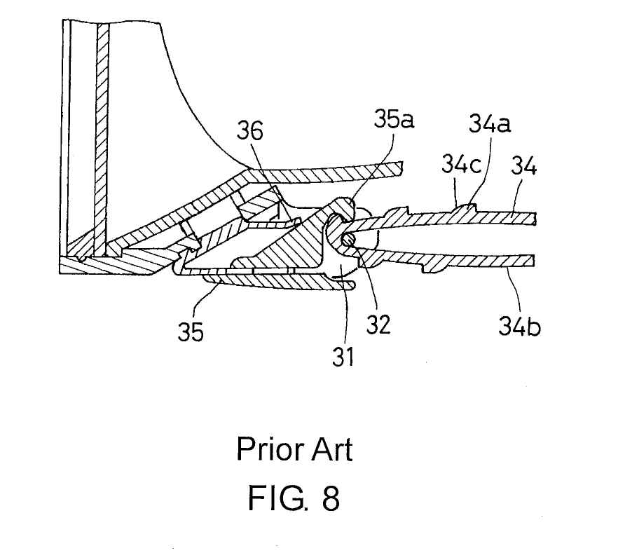

FIG. 9 is a cross-sectional view in a state where the tightening band of the conventional eyewear mounting device shown in FIG. 7 can be loosened.

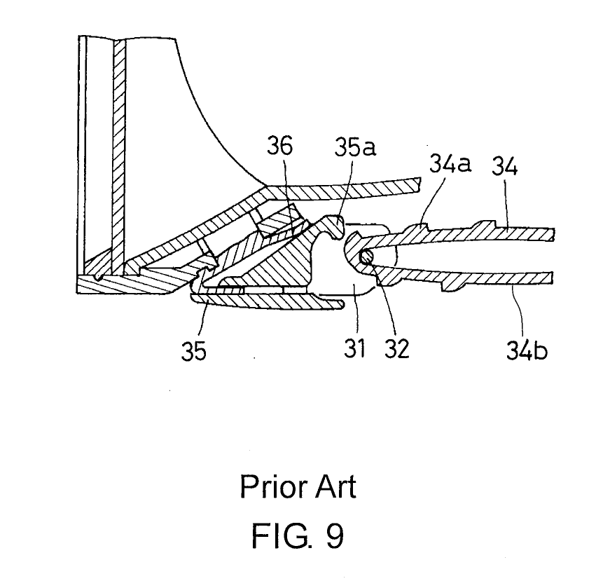

### DETAILED DESCRIPTION OF THE PREFERRED EMBODIMENT

Hereinafter, an embodiment for implementing an eyewear mounting device of the present invention will be described in detail based on drawings.

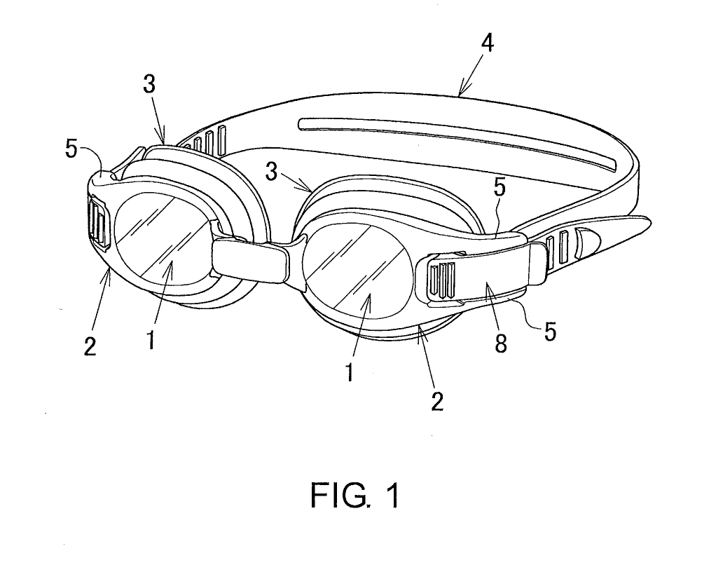

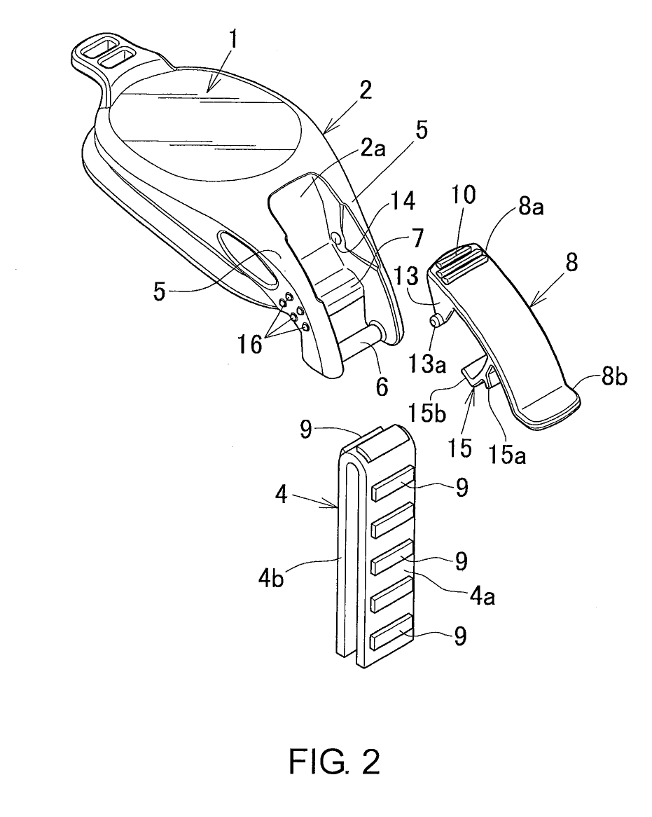

FIGS. 1 to 4 show the embodiment in which the eyewear mounting device of the present invention is exemplified as a swimming goggle. The swimming goggle is comprised of: lenses 1; a frame 2 integrated with the lenses 1; pads 3 provided at a back surface side of the frame 2; and a tightening band 4 connected to both ends of the frame 2.

A pressing surface portion 2a is formed at the end of the frame 2, and a pair of supporting arms 5 and 5 is integrally provided at the pressing surface portion 2a with a required interval therebetween.

A shaft 6 around which the tightening band 4 is wound is provided between tips of the supporting arms 5 and 5, and an engaging portion 7 is provided between the supporting arms 5 and 5 between the shaft 6 and the pressing surface portion 2a of the frame 2. Further, an operating member 8 is rotatably attached between the supporting arms 5 and 5.

Although the tightening band 4 is preferably made of a stretchable member, such as a rubber band, it may be made of a non-stretchable member. A plurality of protruding portions 9 are provided with a required interval therebetween in a longitudinal direction of a surface side of the tightening band 4, and the tightening band 4 is wound around the shaft 6 and is folded.

The operating member 8 is made of an integrally molded product of synthetic resin, such as poly butylene terephthalate and polyamide that are superior in spring characteristics and friction characteristics, and an inner end of the operating member 8 serves as a pressing operation portion 8a and an outer end thereof serves as a pulling-up operation portion 8b. Further, a nonslip projection 10 is provided at a surface side of the pressing operation portion 8a and at a back surface side of the pulling-up operation portion 8b, respectively so that fingers do not easily slip at the time of operation. In addition, a rib 11 for reinforcing a bending strength of the operating member 8 is provided in a center of the operating member 8 between the pressing operation portion 8a and the pulling-up operation portion 8b.

An elastic piece 12 that is elastically deformed by pressing the pressing surface portion 2a of the frame 2 is provided at the operating member in a state of being opposed to the pressing operation portion 8a, further a pair of supporting pieces 13 is provided at the operating member 8 in a state of being opposed to the pressing operation portion 8a, supporting projections 13a formed at tips of the supporting pieces 13 are supported by supporting holes 14 formed in the supporting arms 5 and 5, respectively, and thereby the operating member 8 is rotatably attached between the supporting arms 5 and 5 as described above. It is to be noted that a space S is provided between the elastic piece 12 of the operating member 8 and the pressing surface portion 2a of the frame 2, and that the space S serves as a rotating region of the operating member 8. Accordingly, a rotating condition of the operating member 8 can be appropriately adjusted by making the space S wider or narrower.

An engaging body 15 having an engaging claw 15a and an engaging piece 15b is provided at the operating member 8 in a state of being opposed to an intermediate portion of the pressing operation portion 8a and the pulling-up operation portion 8b. The engaging claw 15a is engageable with any of the plurality of protruding portions 9 provided with the required interval therebetween in the longitudinal direction of the surface side of the tightening band 4 that is wound around the shaft 6 and is folded. When the pulling-up operation portion 8b is pulled with fingers to rotate the operating member 8, the engaging piece 15b engages with the engaging portion 7 provided between the supporting arms 5 and 5 to thereby prevent the operating member 8 from rotating more and from detaching from between the supporting arms 5 and 5.

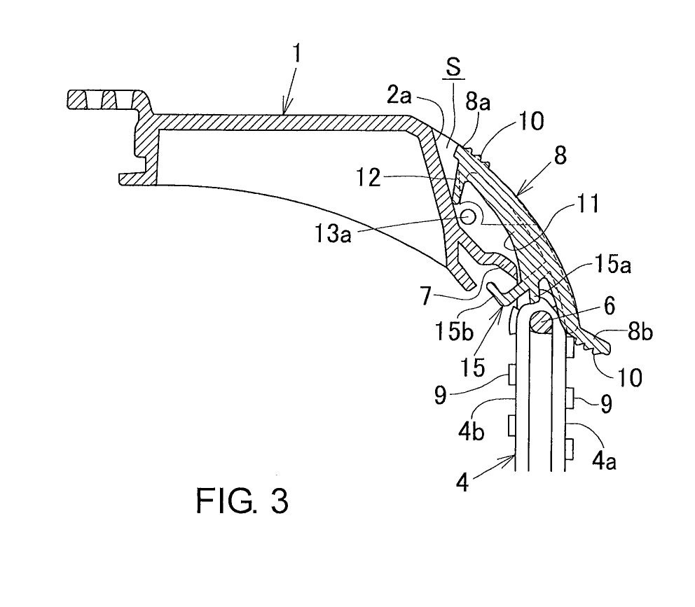

Since the elastic piece 12 of the operating member 8 presses the pressing surface portion 2a of the end of the frame 2 in a state shown in FIG. 3 in the swimming goggle configured as described above, the engaging claw 15a of the operating member 8 engages with any of the protruding portions 9 of the tightening band 4 in a state of pressing the tightening band 4, and thereby the tightening band 4 is in a secured state. It is to be noted that a strength of a force with which the engaging claw 15a of the engaging body 15 presses the tightening band 4 can be appropriately adjusted by changing a thickness and a length of the elastic piece 12 or making the space S wider or narrower.

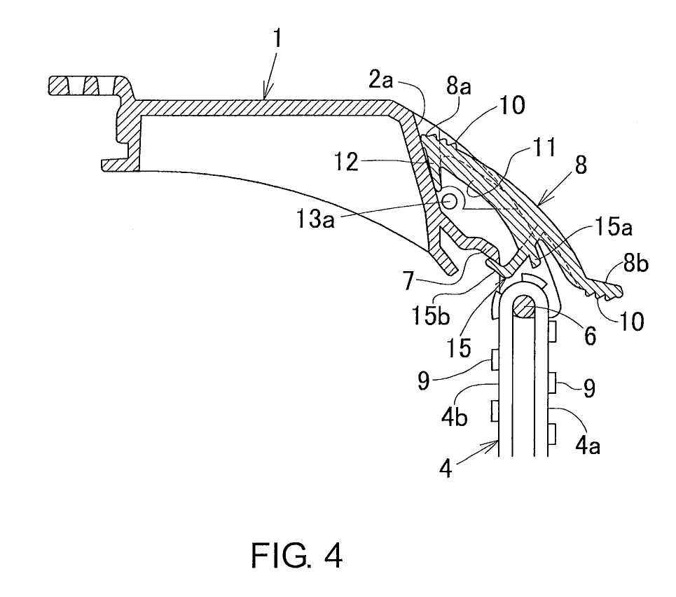

Consequently, when a wearer who wears the swimming goggle pulls a folded side 4a of the tightening band 4 from the state shown in FIG. 3, the protruding portion 9 of the tightening band 4 pushes back the engaging claw 15a of the engaging body 15 with the pulling force, the elastic piece 12 of the operating member 8 is pressed against the pressing surface portion 2a of the end of the frame 2 to thereby be elastically deformed, the operating member 8 rotates centering around the supporting projection 13a, and engagement of the protruding portion 9 of the tightening band 4 and the engaging claw 15a of the engaging body 15 is released to be in a state shown in FIG. 4. It is to be noted that although only fingers of one hand may be used when the folded side 4a of the tightening band 4 is pulled, it may be pulled after the supporting arms 5 and 5 are held with fingers of the other hand so that the worn swimming goggle is not moved. In this case, the supporting arms 5 and 5 can be provided with nonslip projections 16, respectively so that the fingers pressing the supporting arms 5 and 5 do not easily slip.

Additionally, when the folded side 4a of the tightening band 4 is stopped being pulled, the elastic piece 12 of the operating member 8 is pushed back by an elastic force thereof from the pressing surface portion 2a of the end of the frame 2 and again becomes in the state shown in FIG. 3, the engaging claw 15a of the engaging body 15 engages with any of the protruding portions 9 of the tightening band 4, the tightening band 4 becomes in the secured state, and an operation to tighten the tightening band 4 is completed. Note that it is needless to say that the operation to tighten the tightening band 4 can be performed before the swimming goggle is worn.

Next, when the wearer who wears the swimming goggle presses with his fingers the pressing operation portion 8a of the operating member 8 from the state shown in FIG. 3 or pulls up with the fingers the pulling-up operation portion 8b of the operating member 8, the swimming goggle becomes in the state shown in FIG. 4 similarly to the above, and the tightening band 4 can be loosened by pulling an unfolded side 4b of the tightening band 4.

Subsequently, when the operation portion 8a of the operating member 8 is stopped being pressed with the fingers or the pulling-up operation portion 8b of the operating member 8 is stopped being pulled up with the fingers, the swimming goggle again becomes in the state shown in FIG. 3 similarly to the above, the engaging claw 15a of the engaging body 15 engages with any of the protruding portions 9 of the tightening band 4, the tightening band 4 becomes in the secured state, and an operation to loosen the tightening band 4 is completed. Note that it is needless to say that the operation to loosen the tightening band 4 can be performed before the swimming goggle is worn.

The eyewear mounting device of the present invention is configured as described above, and the tightening band 4 can be easily loosened by either operation of pressing the pressing operation portion 8a of the operating member 8 with the fingers or pulling up the pulling-up operation portion 8b of the operating member 8 with the fingers in the state where the eyewear mounting device is worn, thus resulting in easy operation and convenience of the eyewear mounting device.

Further, the operating member 8 for loosening the tightening band 4 is made of one integrally molded product of synthetic resin in the eyewear mounting device of the present invention, thus resulting in easy assembly of the eyewear mounting device.

What is claimed is:

1. An eyewear mounting device comprising:
a frame;
a pressing surface portion formed at an end of the frame;
a pair of supporting arms provided on the pressing surface portion with an interval there between;
a tightening band;
a shaft around which the tightening band is wound, the shaft being provided between tips of the supporting arms; and
an operating member rotatably attached between the supporting arms, wherein
an inner end of the operating member serves as a pressing operation portion and an outer end thereof serves as a pulling-up operation portion,
an elastic piece that is elastically deformed by pressing the pressing surface portion of the frame is provided at the pressing operation portion,
an engaging body having an engaging claw is provided at an intermediate portion of the pressing operation portion and the pulling-up operation portion, and
the engaging claw of the engaging body is engageable with any of a plurality of protruding portions provided in a longitudinal direction of a surface side of the tightening band wound around the shaft and folded.

2. The eyewear mounting device according to claim 1, wherein the operating member is made of an integrally molded product of synthetic resin.

3. The eyewear mounting device according to claim 1, wherein a pair of supporting pieces is provided at the operating member in a state of being opposed to the pressing operation portion, supporting projections formed at tips of the supporting pieces are supported by supporting holes formed in the supporting arms, respectively, and thereby the operating member is rotatably attached between the supporting arms.

4. The eyewear mounting device according to claim 2, wherein a pair of supporting pieces is provided at the operating member in a state of being opposed to the pressing operation portion, supporting projections formed at tips of the supporting pieces are supported by supporting holes formed in the supporting arms, respectively, and thereby the operating member is rotatably attached between the supporting arms.

5. The eyewear mounting device according to claim 1, wherein a space serving as a rotating region of the operating member is provided between the elastic piece of the operating member and the pressing surface portion of the frame.

6. The eyewear mounting device according to claim 2, wherein a space serving as a rotating region of the operating member is provided between the elastic piece of the operating member and the pressing surface portion of the frame.

7. The eyewear mounting device according to claim 3, wherein a space serving as a rotating region of the operating member is provided between the elastic piece of the operating member and the pressing surface portion of the frame.

8. The eyewear mounting device according to claim 4, wherein a space serving as a rotating region of the operating member is provided between the elastic piece of the operating member and the pressing surface portion of the frame.

9. The eyewear mounting device according to claim 1, wherein an engaging portion is provided between the supporting arms between the shaft and the pressing surface portion and the engaging body has an engaging piece, and the engaging piece engages with the engaging portion to prevent the operating member from rotating more when the operating member is rotated.

10. The eyewear mounting device according to claim 2, wherein an engaging portion is provided between the supporting arms between the shaft and the pressing surface portion and the engaging body has an engaging piece, and the engaging piece engages with the engaging portion to prevent the operating member from rotating more when the operating member is rotated.

11. The eyewear mounting device according to claim 3, wherein an engaging portion is provided between the supporting arms between the shaft and the pressing surface portion and the engaging body has an engaging piece, and the engaging piece engages with the engaging portion to prevent the operating member from rotating more when the operating member is rotated.

12. The eyewear mounting device according to claim 4, wherein an engaging portion is provided between the supporting arms between the shaft and the pressing surface portion and the engaging body has an engaging piece, and the engaging piece engages with the engaging portion to prevent the operating member from rotating more when the operating member is rotated.

13. The eyewear mounting device according to claim 5, wherein an engaging portion is provided between the supporting arms between the shaft and the pressing surface portion and the engaging body has an engaging piece, and the engaging piece engages with the engaging portion to prevent the operating member from rotating more when the operating member is rotated.

14. The eyewear mounting device according to claim 6, wherein an engaging portion is provided between the supporting arms between the shaft and the pressing surface portion and the engaging body has an engaging piece, and the engaging piece engages with the engaging portion to prevent the operating member from rotating more when the operating member is rotated.

15. The eyewear mounting device according to claim 7, wherein an engaging portion is provided between the supporting arms between the shaft and the pressing surface portion and the engaging body has an engaging piece, and the engaging piece engages with the engaging portion to prevent the operating member from rotating more when the operating member is rotated.

16. The eyewear mounting device according to claim 8, wherein an engaging portion is provided between the supporting arms between the shaft and the pressing surface portion and the engaging body has an engaging piece, and the engaging piece engages with the engaging portion to prevent the operating member from rotating more when the operating member is rotated.
